(19) United States
(12) Patent Application Publication
(10) Pub. No.: US 2006/0155857 A1
(43) Pub. Date: Jul. 13, 2006

(54) Deterministic session state management within a global cache array

(75) Inventors: James J. Feenan JR., Windham, NH (US); Ming Lei, Fremont, CA (US); Gary Ling, Belmont, CA (US)

Correspondence Address: PERMAN & GREEN, 425 POST ROAD, FAIRFIELD, CT, 06824, US

(73) Assignee: ORACLE INTERNATIONAL CORPORATION, REDWOOD SHORES, CA (US)

(21) Appl. No.: 11/030,528

(22) Filed: Jan. 6, 2005

(51) Int. Cl. G06F 15/16

(52) U.S. Cl. 709/227

(57) ABSTRACT

The present invention is directed to binding a user session in an application to a particular coordination point. The method includes recognizing a defined application session in response to an application generated by a cache. A user session and an origin server that generated the response are bound in a session cookie. Subsequent requests are routed to the same origin server that served the application content for each unique user session based on the session cookie.

### BACKGROUND OF THE INVENTION

1. Field of the Invention

The present invention generally relates to webcaches, and in particular to maintenance and management of web content.

2. Brief Description of Related Developments

Computers have become an integral tool used in a wide variety of different applications, such as in finance and commercial transactions, three-dimensional and real-time graphics, computer-aided design and manufacturing, healthcare, telecommunications, education, etc. Computers are finding new applications as their performance and speeds ever increase while costs decrease due to advances in hardware technology and rapid software development. Furthermore, a computer system's functionality and usefulness can be dramatically enhanced by coupling stand-alone computers together to form a computer network. In a computer network, users may readily exchange files, share information stored on a common database, pool resources, communicate via e-mail and even video teleconference.

One popular type of network setup is known as “client/server” computing. Basically, users perform tasks through their own dedicated desktop computer (i.e., the “client”). The desktop computer is networked to a larger, more powerful central computer (i.e., the “server”). The server acts as an intermediary between a group of clients and a database stored in a mass storage device. An assortment of network and database software enables communication between the various clients and the server. Hence, in a client/server arrangement, the data is easily maintained because it is stored in one location and maintained by the server; the data can be shared by a number of local or remote clients; the data is easily and quickly accessible; and clients may readily be added or removed.

Normally, vast amounts of data are stored in the form of one or more databases residing on a number of hard disk drives of a disk array coupled to the server. The main advantages for storing data in this fashion is because it is relatively inexpensive and because the data is retained even when power is turned off. However, accessing this data can take a relatively long time due to the electro-mechanical nature of hard disk drives. First, the appropriate disk within one of the hard disk drives must be rotated to the desired sector corresponding to the data that is to be read or written. In addition, the servomechanism must move the actuator assembly to place the transducer to the correct track. Only then can the data be written to or read from the disk. Often, data is scattered in many different locations and multiple reads must be performed for a single read or write operation. Given that a transaction might entail initiating numerous read/write operations, the cumulative time required in performing disk I/O operations can add up to become quite substantial. Hence, having to perform numerous disk I/O operations acts as a bottleneck in the flow of data. As a result, it drastically slows down the overall performance of the computer system.

In an effort to reduce the time required to access data, client/server computer systems have now incorporated a section of “cache” memory. Typically, the cache memory is comprised of banks of random access memory (RAM) chips. Hence, data can be accessed electronically rather than electromechanically and cache access can be performed at extremely fast speeds. Another advantage is that implementing a global cache memory allows data to be shared and accessed by multiple users. But since cache memory is volatile, most of the data is stored in the disk array. Furthermore, cache memory costs more than an equivalent amount of hard disk storage. Consequently, the capacity of the cache memory is smaller than that of the disk array. Hence, there is only a limited amount of data which can be retained in the cache at any given time.

When a database user or application runs a query, the data is retrieved from the disk and delivered to the user. The data is also stored in memory with the expectation that some other user or application will want the same data. When the same data is requested the application retrieves the data from the memory without going to the disk. This generally improves response times. A cluster generally describes a group of computers and storage devices that function as a single system. In a memory cache, we can cluster independent caches together. Having a collection of servers or data in a central location can increase the effectiveness and efficiency of security, administration and performance. Clustering can include, for example, segmenting and spreading a database across multiple servers, with each segment of the database residing on multiple servers to achieve some level of redundancy.

Web content, such as from an application or content generating web/application server, can be retrieved and cached. For example, a web cache or cache engine is an Internet application that performs Web content caching and retrieval. When a user accesses a Web page, the cache can store portions of the Web content, such as the web page(s), portion of web pages, images, and data from a database, graphics, HTML text, and other items to be served to the clients' web browser. When another user requests the same Web page, the content, if cached, is retrieved from the Web cache rather than the origin or respective server. When the cache is placed in the request path between the browser and the web-server there are potential single points of failure. With the failure of the cache, all cache content in memory is lost. Since the cache is in the request path requests must either be routed around the cache or the website cannot serve content. With the addition of clustering, caching services as well as website content can still be maintained after a portion of the cluster has failed. With reliable caching services the single webcache or cluster acts as a surrogate of the origin server. Thus, responses to requests are returned by cache to the requester as if they were responses from the origin server. Additionally, information not in the cache, for which the requestor's application depends, is forwarded to the origin server for additional content.

Web cache clustering is a loosely coupled array of caches that together provide the image of a global cache. In current implementations, there is an assumption that a load balancer front ends the clustered cache instances to provide ip failure detection and failover. No other assumptions in load balancer capabilities are incorporated in the design. Thus consecutive client requests loadbalanced across a cache cluster most likely would be distributed among the members of the cluster. Capabilities such as session affinity/binding depended on maintaining the image of a global cache.

An application is comprised of multiple requests and/or queries. As each query executes, it optionally generates results that may be stored and shared with subsequent requests coming from the same end user. This is referred to as session state. Session state is generally maintained at the local of an Origin Server. Initially established at an origin server and identified by a token either in the form of a URL parameter and/or cookie, subsequent requests attach this token to identify the session. There has been a good amount of work trying to direct subsequent requests through to a single controller and ensuring that the routing of the subsequent requests are again routed to the session originator and/or maintainer.

A loosely coupled array of caches can form a cluster that exports the view of a single cache. This cluster can maintain session state within an in memory session state table. This establishes independent control points within the cluster for the storage of session information. In this arrangement, there is no coordination of the session state or characteristics of the session. To enforce proper routing, a routing dependency has to be created with an external loadbalancer to perserve the routing of subsequent requests to a specific cache. Thus, all subsequent requests for a client would be routed to the correct coordination point to manage the session state and forward requests for uncached information to the correct origin server.

Additional complications can be realized when configuring any of these systems in a hierarchy. Since each cache array has to act as a single cache/session coordinator, session state has to be maintained relative to the locality of any decision.

### SUMMARY OF THE INVENTION

The present invention is directed to binding a user session in an application to a particular coordination point. In one embodiment the method comprises recognizing a defined application session in response to an application generated by a cache. A user session and an origin server that generated the response are bound in a session cookie. Subsequent requests are routed to the same origin server that served the application content for each unique user session based on the session cookie.

In another aspect the present invention is directed to a method of maintaining a session state in a loosely coupled array of caches. In one embodiment the method comprises receiving in a cache in the array of caches a first request from a client for a session with an application on a website, transmitting the first request to an origin server that generates a content of the application from the website and receives an application generated response that includes a value that identifies the session, and after receiving the application and application generated response in the cache, recognizing that this is a session for a particular site, generating a session cookie in the cache identifying the origin server associated with the first request, the application associated with the first request and a configured timeout, wherein a subsequent non-cached request from the client will be forwarded to the origin server and maintain session information without establishing a new session.

In a further aspect, the present invention is directed to a method of binding a user session in an application to a coordination point for affinity of future requests. In one embodiment the method comprises, after establishing an initial session, tagging a session identification cookie with information identifying the cookie as pertaining to a particular user and the particular user's session in an application, identifying the user's session, from the information in the session identification cookie, as an application session to be tracked, and appending a session tracking cookie that identifies an origin server as handling all requests by the particular user for the application session and a cache array that made an initial decision to establish a connection with the origin server.

In another aspect, the present invention is directed to a method of cookie based session tracking in a loosely coupled cache array. In one embodiment, the method comprises recognizing a user session, binding a request associated with the user session to an origin server, returning a cookie/URL from the origin server to the cache in response to the request, inserting the origin server binding information into a memory session table, and using the table to determine an origin server for subsequent requests.

In a further aspect, the present invention is directed to a computer program product. In one embodiment, the computer program product comprises a computer useable medium having computer readable code means embodied therein for causing a computer to bind a user session in an application to an origin server, the computer readable code means in the computer program product comprising computer readable program code means for causing a computer to recognize a defined session in the origin server, computer readable program code means for causing a computer to bind a user session and the origin server that generated the response in a session cookie, computer readable program code means for causing a computer to route subsequent requests to the origin server for each unique user session based on the session cookie.

### BRIEF DESCRIPTION OF THE DRAWINGS

The foregoing aspects and other features of the present invention are explained in the following description, taken in connection with the accompanying drawings, wherein:

FIG. 1 is a block diagram of one embodiment of a system incorporating features of the present invention.

FIG. 2 is a block diagram of another embodiment of a system incorporating features of the present invention.

FIG. 3 is a block diagram of another embodiment of a system incorporating features of the present invention.

FIG. 4 is a flow chart illustrating one embodiment of a method incorporating features of the present invention.

FIG. 5 is a block diagram of one embodiment of a system architecture incorporating features of the present invention.

FIG. 6 is a block diagram of one embodiment of a typical architecture that may be used to practice the present invention.

### DETAILED DESCRIPTION OF THE PREFERRED EMBODIMENT(s)

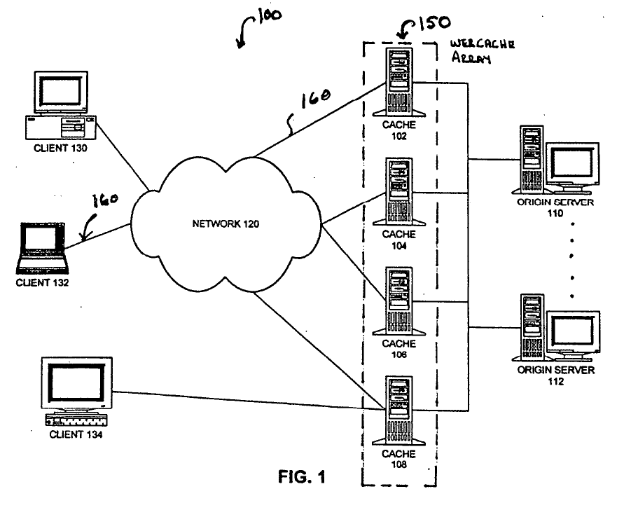

Referring to FIG. 1, a block diagram of a system 100 incorporating features of the present invention is illustrated. Although the present invention will be described with reference to the embodiment(s) shown in the drawings, it should be understood that the present invention can be embodied in many alternate forms of embodiments. In addition, any suitable size, shape or type of elements or materials could be used.

As shown in FIG. 1, in one embodiment the system 100 includes a cache array 150. The cache array 150 generally comprises a series of cache servers, or computing systems 102-108. The cache array 150 can include any suitable number of cache servers 102-108. The cache array 150 is coupled to one or more origin servers 100-112 (also referred to herein as a collection of webservers). In alternate embodiments, any suitable number of origin servers can be included. A network 120, such as for example the Internet or World Wide Web (“WWW”) couples the cache array 150 to anyone of a number of potential clients (or users) 130-134.

In one embodiment, the caches 102-108 are web caches configured to store web pages and/or parts of web pages that are accessed from clients and generated by origin servers 110-112. A home web page could be, for example, particularly popular page accessed by many users. That page may therefore be stored in most or all of the caches of the array 150. Alternatively, the most requested objects may be identified (e.g., from a log file), possibly preloaded and identified as being replicable across the caches.

Each origin server 110-112 generally stores and is adapted to serve web content or pages, also referred to as sites or applications. The clients 130-134 can generate requests or queries for the content of any one of the various sites served by the origin servers. For example, a user 130 may desire to log into or access an application that is served by origin server 110.

A session is generally defined as an active communication, measured from beginning to end, between devices and applications over a network. A client 130-134 can initiate a session by sending a query or request for the web content, which can also be referred to as logging in. The query can be embodied as Hypertext transport protocol (“HTTP”) request. The HTTP response can include for example, a “SET COOKIE” header request that defines certain values related to the response, such as for example, <name> <value> <domain> <path> <time out>. The SET COOKIE flag can be used to generate the header that is used to establish the session. The contents from the response header injected is important because it established a session. The cache array 150 can parse the header for this cookie that has been set for the directives as to what to do with the content, which is served from one of the origin servers 110-112.

The disclosed embodiments are generally adapted to maintain the loose coupling of the cluster array and encapsulate the session state and session binding information to make proper session state decision in a cookie. A “cookie” is a mechanism that is a feature of the Hypertext Transport Protocol (“HTTP”) used in the Internet and the WWW, and is a term that is well known and used in the art. For this methodology, a client must generally have cookies enabled for their browser.

There are two basic pieces of data or information maintained in the cookie. The first piece of information is an identifier that is a unique identity of the coupled array of webcaches 102-108 of FIG. 1.

Generally, a unique identifier needs to be assigned to the entire cluster. A cluster identifier (“CID”) can be used in hierarchical caching. Since each cache member generally knows the entire member list, the cluster 150 can use the (ip, port) of the lowest (or highest) ranking “live” cache as the CID for the entire cluster. This “enhanced” CID works even in situations where a network partition splits the cluster into two. The key here is that whatever name is used it is unique to the cluster and every member knows that name. This is used to evaluate if the session information is the information for this particular cluster. Additionally we are flexible in configuration changes and actively partition the cooperation of the loosely coupled array. A mechanism should be included to ensure that the list of backend servers that generate content do not change.

In a session state the query executes at the origin server, stores the results and shares the results with subsequent requests for the content from the same user. A cookie is generated in response to the query with a value that identifies the particular session. A cookie can be inserted into the response that tracks the session cluster and origin server information. In this way, session information can be identified for a particular cache cluster, such as for example cache cluster 150 of FIG. 1, and that binding decision between this user and the webserver handling that user's request was made by this cache array.

For example, if a user or client 130-134 wishes to establish a session at the site www.jay.com, the user initiates the HTTP login for the site. The cache cluster 150 receives the login request and attempts to determine ownership of the requested web content. The origin server 110-112 can generate for example, a cookie “Session 123”, that identifies the current session with the particular user. This information is sent back to the cache 102-108. A session cookie or session tracking cookie can then be generated by the cache cluster 150, for example “MYSESSION” that is attached to the response. While the initial request goes directly to any of the origin servers 110-112, all subsequent requests for non-cached content for “MYSESSION” can be identified by the application and session tracking cookie attached to the subsequent request and will be directed to the same origin server. This can be seen in the case of a online “shopping cart” as that term in commonly understood for Internet or web based shopping. Here, when a user has added to the shopping cart and wishes to leave the shopping cart and access another application, only to return to the shopping cart, the user can access the other application and return to the shopping cart in a seamless manner, i.e. without the need to establish a “new” session.

Referring to FIG. 1, once a client 130-134 connects with an origin server 110-112, a session is bound to connections for all subsequent requests. For example, in a situation where there are ten origin servers [OS1 . . . OS10], we seek to connect with the least loaded server, such as OS5, if a session is started. We then bind to OS5 because that is where the actual application session originated or started. If we moved to OS6, the previous state would not be found and we would have to reestablish the session.

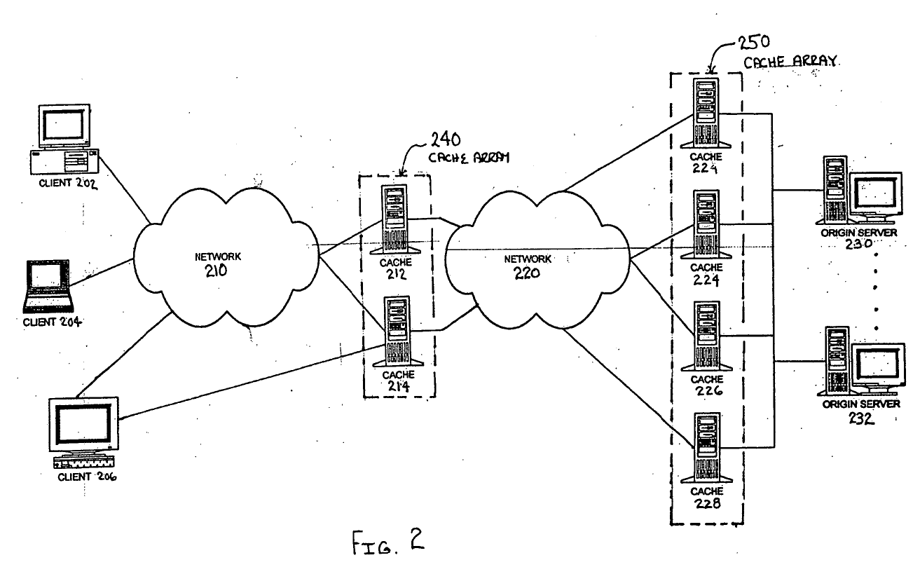

In a cluster environment, each cluster such as 240 and 250 of FIG. 2 has its own cluster identification (“CID”) and appears to be entirely independent. A unique CID is assigned for each cluster 240, 250 of the entire cluster 150 of FIG. 1. The CID number has to identify the cluster uniformly in all situations.

For a stateful session response from the origin server 110-112, a cookie is generated and added to the response that binds together the global cache identification and the originating session's origin server. The cookie binds the cache to the site with the connection. The client (e.g. browser) always stores the cookie. Subsequent requests from for example, clients 130, 132, forward the cookie to the cache cluster 150. The present invention will extend the session binding capabilities to allow affinity of the sessions to a chosen origin server 110, 112 across cluster membership 150 using a cookie based mechanism. The following functionality will be implemented. The session binding definitions will be enhanced to optionally track sessions with a client stored cookie. A cookie will be added to maintain the session origin server binding. The name given to the cookie is for e.g. “ORA_WX SESSION.” The hard failure of the origin server 110, 112 will result in the failover of the session binding to a new origin server, defined as having the same services. Knowledge of the service relationship and deterministic factors of services can be maintained across the cluster membership. There is reliable failover of origin server services. The cookie will be hop-by-hop processed as the session binding is uniquely matched to a particular cache/cluster. In FIG. 2, the request can go directly from a cache to the origin servers, bypassing the other cache. Each cache is interested in processing the session it tagged. If the cache did not tag the session, the cache passes it through.

The system of FIG. 1 illustrates the use of four caches or cache servers 102, 104, 106 and 108, although more or less caches could be included. In one embodiment the caches include hybrid caches. Some or all of the caches may participate in a cache cluster 150, a loosely coupled collection of cooperating cache instances. The caches 102-106 are coupled to, for example, origin servers 110, 112, which generate or serve data objects for clients, users and other requesters. Only two origin servers are shown for this example in FIG. 1, although more or less could be used. The caches 102-106 are coupled to for example, clients 130, 132 via network 120, which may comprise the Internet. A cache 102-106 may also be linked directly to a client, or may be linked via some path other than network 120, such as client 134. In alternative embodiments, any number of caches or cache servers may cooperate (e.g., two or more), and may be coupled to any number (i.e., one or more) of origin servers. In one embodiment, another layer of caches or cache servers (i.e., one or more) may be interposed between caches 102-108 and the origin servers or between caches 102-108 and the clients 130-134 or other caches distributed, for example, in a hierarchical configuration in the network. In addition, although FIG. 1 depicts each cache 102-106 as operating on a separate machine, multiple caches may operate on a single machine in other embodiments of the invention. Yet further, a hybrid cache may be operated on an origin server.

The caches 102-108 shown in FIG. 1 generally store data objects such as web pages, portions of web pages, images, data from a database and other items to be served to clients operating suitable applications (e.g., a web browser or a database application). Clients 130-132 may operate different applications and/or different operating systems. Generally, the data stored on or generated by origin servers 110, 112 define a domain of cacheable data that may be requested by the clients.

Referring to FIG. 1, the domain of cacheable data can be partitioned among the four caches so that each is the “owner,” or assumes primary responsibility for a portion of the domain, such as for example, approximately one-fourth of the domain. In alternate embodiments, any suitable method of dividing the domain among the caches may be applied. For instance if one cache machine was larger than others, it would have more capacity and could manage more objects. Alternatively, the name of a data object may be hashed via a hashing function to produce a hash value. Each cache may then assume primary responsibility for objects that hash into its quarter of the possible hash values. Or, the modulo of the hash value over the number of caches may be calculated, with each cache taking ownership of objects that hash to it.

In one embodiment, a data object's “name” may comprise or be generated from one or more components (e.g., a file name, object name or other identifier of the object). For example, a unique object identity may be derived from an identifier (e.g., URL) of the object, one or more session attributes (e.g., of a requestor's session), information or parameters included in a request for the object, etc.

Each cache can generally determine whether it is the primary cache for a given object. If it is not, the cache can determine which of the caches in the array or cluster is the primary. A cache may be required to always store the data objects that it owns. Alternatively, a cache may be able to remove primary content (content it owns) from storage under certain circumstances. These “removal” circumstances could include for example that the content is rarely requested, the content is very large, the content quickly becomes invalid, the content can be retrieved from an origin server or other source quickly and inexpensively, or other content is requested more often and the memory space is needed, or there is a user directive to invalidate the data.

During operation of the system depicted in FIG. 1, caches 102-108 receive data requests or queries from clients 130-134 and serve the requested data, either from their cache storage or after retrieving the data from an origin server or another cache. Therefore, a user or data requestor 130-134 may be guaranteed that a requested data object will be served, regardless of which cache receives the request. If the request is received at a cache other than the primary cache of the requested object, that cache may retrieve the object directly from an origin server 110-112 (i.e., without routing or passing the request to the object's primary cache).

The cluster 150 of caches 102-108 shown in FIG. 1 are trying to export the view of a cluster wide global cache. Any request forwarded to the individual members (102-108) of the cache 150 needs to recognize that the session state information is being maintained by the cluster 150. If the topology of the system shown in FIG. 1 was configured in a manner to arrange cache arrays 102-108 as both a proxy and reverse proxy arrangement between the client 130-132 and the origin server 110-112, all of the session state as well as the session binding information would have to be uniquely identified for each of these arrays, independent of the other. Generally, two cache clusters would need to be configured. An example of this is shown in FIG. 2.

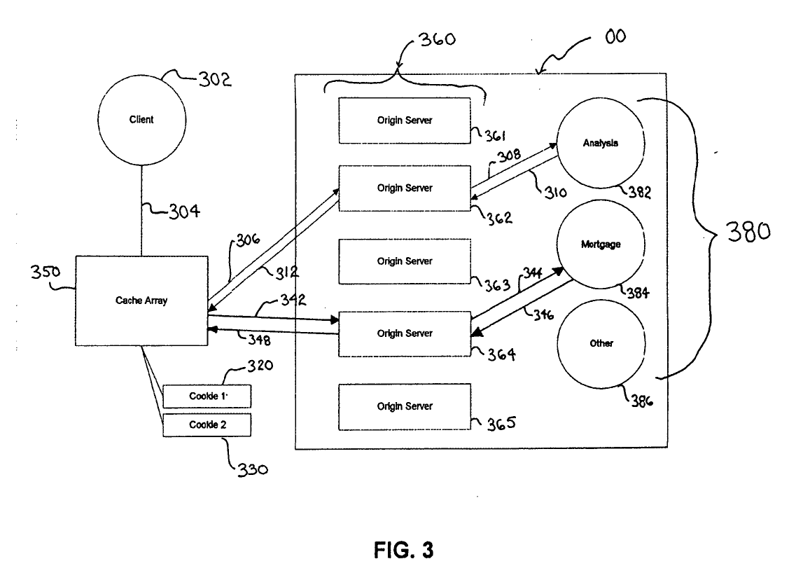

There are four pieces of information that are configured for the cache cluster 150 of FIG. 1. The application name that starts the session, the identifier it uses as an identity to indicate a session, the timeout information for a session and the origin server that generates the content for the application. Referring to FIG. 3, an example of this would be the application www.mybank.com/anaysis, 382. The application www.mybank.com/anaysis, 382, is a hosted environment within a website 300 at www.mybank.com. The site 300 can include for example five origin servers 361-365 that are configured to run the applications for the site 300 www.mybank.com. Other applications 380 within the site 300 can include for example, and without limitation, “mortgage” 384 and “other” 386. A client 302 can browse the site all it wants, but once the client 302 logs into analysis application 382 for the site 300, the analysis application 382 generates a cookie named “mybanksession”, with a value associated with it that identifies this client session. For the sake of example, the request 304 to “login” was sent by the cache array 350 to origin server 362 as login request 306. From this point on, any further requests from client 302 should be sent to origin server 362 since that origin server established this session and will maintain this session. Cache array 350 recognizes the “mybanksession” cookie in the response 312 to the login 306 sent from the cache 350 to the origin server 362, and generates a session cookie 320 that identifies the cluster (cache array 350), the site 300 [www.mybank.com], the application analysis 382 and a configured timeout [e.g. 5 minutes]. The session cookie also directs that all subsequent non-cached requests from this client 302 should be forwarded to origin server 362. The session cookie 320 is only valid for this cluster 350 since a cluster positioned in the network “infront” of this cluster 350, such as cluster 210 in FIG. 2, would not understand what origin server 362 is. Additionally, the client 302 could log 344 into another application on the site, for example “mortgage” 342. This could establish and maintain another session with origin server 364 and two session state cookies 320, 330 should be maintained. The difference between these would be part of the information maintained in each cookie 320, 330. The first cookie 320 would indicate the affinity with origin server 362 and the second cookie 330 would indicate the affinity with origin server 364.

In one embodiment, the session state and session binding information can be properly maintained in a cooperative configuration. A “session” can generally be described as anytime a user logs onto a Website. A “session” is maintained within a Website. Session state generally refers to maintaining a virtual active link on the Website. Each level for the network making decisions is cooperatively configured and the routing path of a request is not fixed through the same path. One way to ensure that decisions are the same over time is to bind all the routing at each level, resulting in a fixed routing through the network. This could result in an unevenness of load. By encapsulating the session information within the cookie, it allows for breaking the routing at each loose coupling and sharing data (for the members of the identified array) within the cookie.

Session binding binds a user session to a particular application Web server. A session definition comprised of a unique session name, and cookie or embedded URL parameter (for those browsers that do not use cookies) is configured with the cache. When the cache recognizes this defined session, a binding between the user session and an origin server is established. Optionally, if the origin server supports session migration, this binding could be to the group of origin servers supporting this capability. In the context of this document it is assumed that it is a single origin server maintaining a particular user session.

This feature allows subsequent routing of requests to the same origin server for a unique user session. This allows stateful request affinity to particular webservers.

When a request first comes in, load balancing can be used to decide which application Web server to send the request to. If the request establishes an application session it will identify the session in the response. The session identifier is matched against configured identifiers. The session is identified and establishes origin server binding within the cookie. All information to allow subsequent routing of requests back to the same webserver is maintained in the cookie. Additionally, if a subsequent request detects the failure of the originally selected webserver, the request is resent to another webserver of equal capabilities. The session/server binding is updated after failover is performed.

The important pieces of information that need to be maintained in the cookie can include which origin server maintains the session, the Cluster ID, any Time Out (that an incoming request cookie has timed out), the path and the site (identity to access) is the time out information related to the session and the origin server index of the shared configuration of the array.

These pieces of global information are maintained in the cookie and shared, however the sharing is only valid for a given cluster definition.

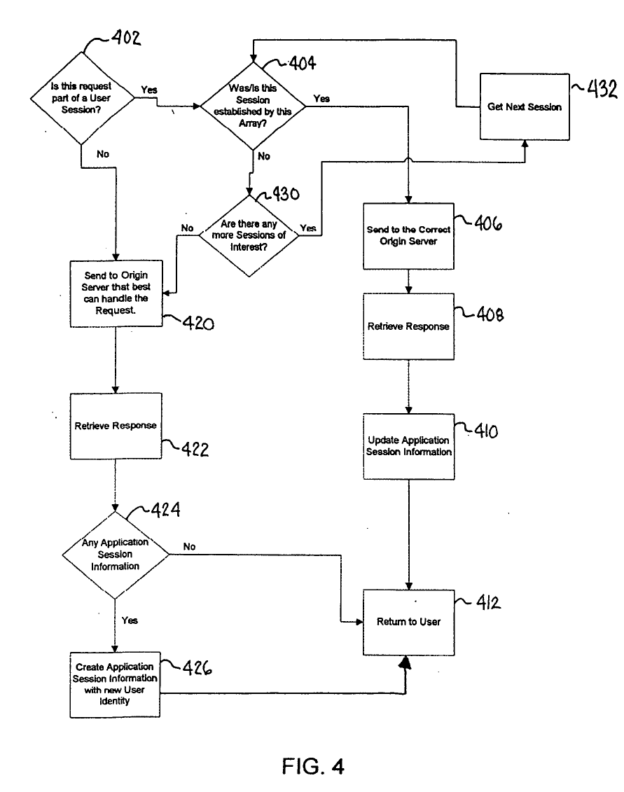

Referring to FIG. 4, one embodiment of a method incorporating features of the present invention is illustrated. Once a request for an application is generated, it is determined in step 402 if the request, for example a login, is part of a user session, meaning that the user is already logged into the session. If not, the request is routed 420 to the origin server that is best suited to handle the request. This origin server is generally the one that owns the application content. The response is retrieved 422. It is determined 424 as to whether any application session information is included in the response. If so, a session cookie, including application session information and a new user identity is created 426 and the application content is returned 412 to the user. If it is determined 424 that there is no application session information, i.e. a session has not been established, the application is returned 412 to the user.

If it determined 402 that the request is not part of a user session, it is determined 404 whether the session was or is established by the current webcache array. If yes, then the request is sent 406 to the correct origin server. The correct origin server retrieves 408 the response, the application session information is updated 410 and the application is returned 412 to the user.

If the session is not established 404 by the current array, then it is determined 430 whether there are any more sessions of interest. For example, a request may be coming in with more than one, or multiple cookies. The array may have established one, but not the other. If there are no more sessions of interest, we proceed with sending 420 the request to the origin server that best can handle the request. If there are more sessions of interest, we go to get 432 the next session and determine 404 whether this session was/is established by this array.

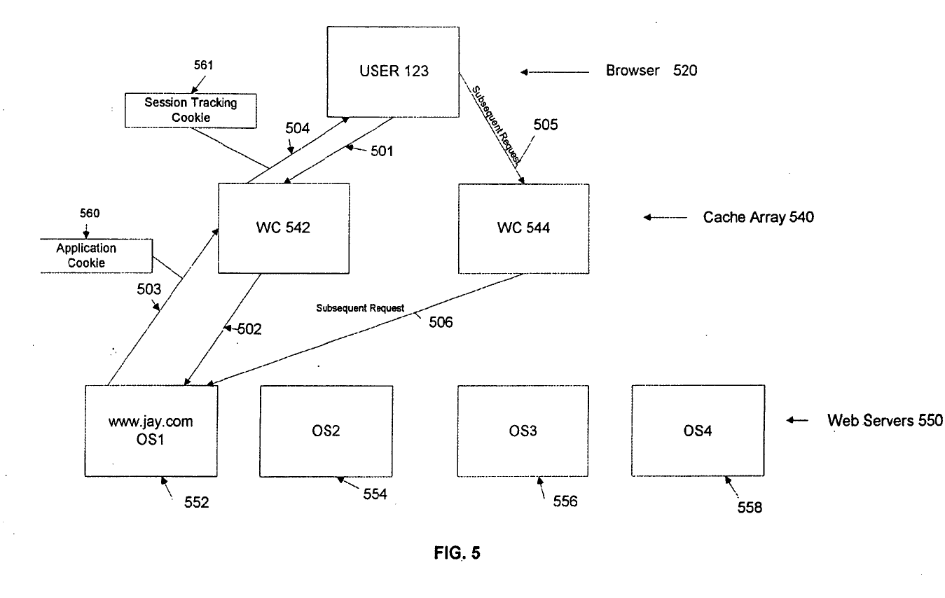

Referring to FIG. 5, one embodiment of a method incorporating features of the present invention will be described. The basic architecture of the system described with reference to FIG. 5 includes a browser 520, a cache array 540 and web servers 550. A user, identified as USER123, makes an initial request 501 through the browser 520 for a session at www.jay.com. The request is passed to the cache array 540 where it is routed, using any conventional routing process, to cache 542, identified as WC542.

The webcache WC542 determines if any previous session has been established, and if not routes 502 the request to the appropriate origin or webserver 542 for the site www.jay.com. The request in 502 includes the identifier of the user, USER123, and the routing part identifier, WC542. The session is established at the webserver 542 for www.jay.com. The session ID is tagged as mysessionjayl23 and id “jay 123.” The value in this example indicates that it is for user 123 and the user's session in the “jay” application. This value is assigned to an application response cookie 560 “mysession”. The response cookie 560 is interpreted by WC542 and identified as an application session that must be tracked. WC542 appends a session tracking cookie 561 that establishes that webserver 552 is handling all requests for this user 123 for site www.jay.com, and as well as that the cache array 540 made the initial decision to establish the connection with the collection of webservers 550 [origin servers].

These response cookies including session tracking cookie 561 and their information are routed back to the browser 520 where the information from the cookies are stored. If the user will subsequently initiate a subsequent request 505 to reestablish the session, cache array 540, in this example, WC544, will send the cookie information back for all such requests to the site www.jay.com. The information in the session tracking cookie 561, that is included in the subsequent request 505, will identify that a decision has to be made by this cache array membership 540 and the request 506 to the correct webserver handling the all www.jay.com requests for user 123.

When a cache in the cache array 540 receives the subsequent request 505, it is able to identify the subsequent request 505 as a request for a session by the cookie 561. The cache in the cache array 540 receiving the request 505, in this case indicated as cache WC 544, has to recognize the session ID in the cookie 561, mysessionjayl23 and jayl23, as of interest, i.e. it is a “session.” This identifies that the binding decision between this user, user 123, and the webserver handling the user's request, was made by this cache array 540, and which webserver of web servers 550, is handling all requests of the site www.jay.com for the user 123. This array identity is also important in the hierarchical case since there may be a cache array out in the network and the downstream origin servers are another set of caches. Only the caches immediately in front of this site, ww.jay.com, has to interpret that user 123 goes to webserver 552.

The present invention will extend the session binding capabilities to allow affinity of sessions to a chosen origin server across cluster membership as well as identification of the binding relationship to a specific cluster. A webcache cluster acts as a surrogate to the origin server in which it caches information. In this environment, the session maintenance should mimic that of the session maintained within the origin server. For instance if a session is designed to timeout in 5 minutes and subsequent requests access cached information without incurring a miss, the activity level of the session is extended. Additionally, if a webcache is deployed in a hierarchy of clusters as in FIG. 2, only the request information related to the local cluster is relevant to the local session binding operations. Sharing of this information will be accomplished by inserting a cookie in the request/response so that the session cluster and server information can be tracked within subsequent requests. Subsequent client requests across the cluster membership will evaluate the information to determine if the related session and origin binding information is valid. If this information is both valid and identified as being maintained in the local cluster, it will be used to process the request. If either the information is not valid (e.g. expired or the request is identified with another webcache cluster), it will be processed as a request not bearing the cookie.

When configuring the cache to identify session attributes, the current configuration allows for two methods of session binding—cookie and URL based. The code logic could be for example:

1. Set-Cookie Format—The Set-Cookie format generated by webcache and sent back to the client would be of the following format.

Set-Cookie:ora_WX.SESSION=<osindex>,<os-ip>,<os-port>; expires=<configured timeout value>, Application (Path←Application, for example, Payroll or Benefits)

2. Cookie Format—The format of the cookie will be:

Cookie: ora_wcs=<name>

<name>:=<OSindex>,<OS-IP>,<OS-Port>

3. When an origin server response is received by a cache, Set-Cookie analysis is done for any new session bindings. If a site match occurs and we are currently acting upon a request with a ora_wxs.session cookie, then a new Set-Cookie is sent back with the response with an updated timeout value. If this is a new match, then we add the ora_x cookie.

4. When a request enters webcache if the ora_wxs.session cookie is passed with the request, then 1) match the CID for the site; 2) must match the site of interest; and 3) the session binding information must exist. The origin server identity in the ora_x session cookie is used to look up the entry. This origin server identity is used for routing the request. The ora_x session cookie is stripped and is not forwarded to the OS, but the OS binding is used.

5. Failover—If a connection to the bound OS has a hard failure, for example a connection cannot be established, [WSTATUS_OS_CONNECT_FAILED, etc.] the session will be broken and if the origin server has session failover capabilities, another origin server with the same session capabilities will be selected.

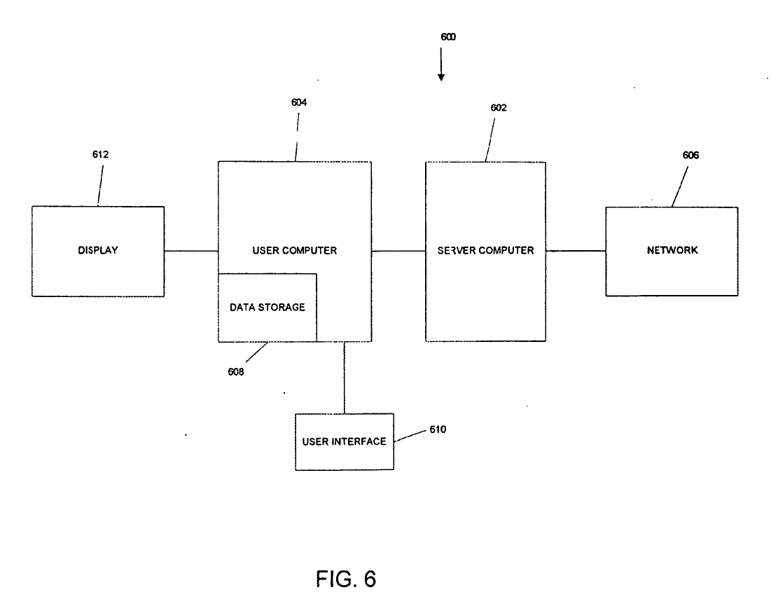

The present invention may also include software and computer programs incorporating the process steps and instructions described above that are executed in different computers. In the preferred embodiment, the computers are connected to the Internet. FIG. 6 is a block diagram of one embodiment of a typical apparatus 600 incorporating features of the present invention that may be used to practice the present invention. As shown, a computer system 602 may be linked to another computer system 604, such that the computers 602 and 604 are capable of sending information to each other and receiving information from each other. In one embodiment, computer system 602 could include a server computer adapted to communicate with a network 606, such as for example, the Internet. Computer systems 602 and 604 can be linked together in any conventional manner including a modem, hard wire connection, or fiber optic link. Generally, information can be made available to both computer systems 602 and 604 using a communication protocol typically sent over a communication channel or through a dial-up connection on ISDN line. Computers 602 and 604 are generally adapted to utilize program storage devices embodying machine readable program source code which is adapted to cause the computers 602 and 604 to perform the method steps of the present invention. The program storage devices incorporating features of the present invention may be devised, made and used as a component of a machine utilizing optics, magnetic properties and/or electronics to perform the procedures and methods of the present invention. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 602 and 604 may also include a microprocessor for executing stored programs. Computer 602 may include a data storage device 608 on its program storage device for the storage of information and data. The computer program or software incorporating the processes and method steps incorporating features of the present invention may be stored in one or more computers 602 and 604 on an otherwise conventional program storage device. In one embodiment, computers 602 and 604 may include a user interface 610, and a display interface 612 from which features of the present invention can be accessed. The user interface 608 and the display interface 612 can be adapted to allow the input of queries and commands to the system, as well as present the results of the commands and queries.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A method of binding a user session in an application to an origin server comprising:
recognizing a defined session;
binding a user session and an origin server of the defined session in a session cookie; and
routing subsequent requests for the user session to a same origin server for each user session based on information stored in the session cookie.

2. The method of claim 1 wherein a session definition of the defined session includes a unique session name.

3. The method of claim 2 further comprising configuring a session tracking cookie within a cache that routed an initial request for the session to the origin server, that includes a unique session name included in the session definition, and appending the session tracking cookie to an application cookie returned from the origin server.

4. The method of claim 1 further comprising:
defining in an initial request for a defined session, a unique session name in a cookie or embedded URL parameter that is returned to the user; and
consecutively routing subsequent requests from the user for the defined session to the same origin server to allow stateful request routing for the subsequent requests based on the cookie.

5. The method of claim 3 wherein the session tracking cookie includes a global cache identification for the request across a loosely coupled array of caches in order to bind the session to the origin server.

6. The method of claim 1 further comprising:
receiving a subsequent request from the user for the defined session;
determining a session identifier from the session cookie forwarded by the user with the subsequent request;
updating a session timeout value from the session cookie; and
connecting with the origin server associated with the user session if the defined session is valid.

7. The method of claim 1 wherein the session cookie is formatted to include:
an identity of the origin server;
a unique identifier for a loosely coupled array of caches that handled an initial request for the user session; and
a timeout value of the defined session.

8. The method of claim 1 further comprising configuring the session cookie to include:
a routing path identifier including an identity of a handling cache and the origin server; and
a session identifier generated by the origin server that uniquely identifies the user session associated with a user.

9. The method of claim 8 further comprising including in the session cookie an identifier of a location of an origin server to which an initial request to establish the user session was transmitted.

10. A method of maintaining a session state in a loosely coupled array of caches comprising: receiving in a cache in the array of caches a first request from a client for a session with an application on a website;
transmitting the first request to an origin server that generates a content of the application from the website and receives an application generated response that includes a value that identifies the session; and
after receiving the application and application generated response in the cache, recognizing that this is a session for a particular site, generating a session cookie in the cache identifying the origin server associated with the first request, the application associated with the first request and a configured timeout, wherein a subsequent non-cached request from the client will be forwarded to the origin server and maintain session information without establishing a new session.

11. The method of claim 10 further comprising:
receiving a subsequent login request from the client for a second application on the website;
transmitting the subsequent request to a corresponding origin server;
the webcache generating another session cookie after receiving an application generated response from the second application that binds the subsequent login to the second application to the corresponding origin server.

12. The method of claim 10 further comprising using load balancing to determine which second origin server to send the second request to.

13. A method of binding a user session in an application to a coordination point for affinity of future requests comprising:
after establishing an initial session with an origin server, tagging a session identification cookie with information identifying the cookie as pertaining to a particular user and the particular user's session in an application;
identifying, from the information in the session identification cookie, as an application session to be tracked; and
appending a session tracking cookie that identifies the origin server as handling all requests by the particular user for the application session and a cache array that made an initial decision to establish a connection with the origin server.

14. The method of claim 13 further comprising routing the session identification cookie and the session tracking cookie to the particular user for storage.

15. The method of claim 13 further comprising, in a subsequent request for the application from the particular user, sending the session identification cookie and the session tracking cookie to a cache array wherein the receiving cache receiving the subsequent request identifies a binding decision between the particular user and the application session and sends the subsequent request to the origin server.

16. A method of cookie based session tracking in a loosely coupled cache array comprising:
recognizing a user session;
binding a request associated with the user session to a origin server;
returning a cookie/URL from the origin server to the cache in response to the request;
inserting the origin server binding information into a memory session table; and
using the table to determine an origin server for subsequent requests.

17. The method of claim 16 further comprising, in response to a subsequent request, identifying the subsequent request as a request for a session by the cookie, identifying the session in the cookie from a session identifier in the cookie, and routing the subsequent request to the origin server identified in the cookie.

18. A computer program product comprising:
a computer useable medium having computer readable code means embodied therein for causing a computer to bind a user session in an application to an origin server, the computer readable code means in the computer program product comprising:
computer readable program code means for causing a computer to recognize a defined session;
computer readable program code means for causing a computer to bind the defined session and an origin server that generated a response to the defined session in a session cookie;
computer readable program code means for causing a computer to route subsequent requests for the defined session to the origin server that served the defined session for each unique user session based on the session cookie.
